(19) United States
(12) Patent Application Publication
(10) Pub. No.: US 2003/0020881 A1
(43) Pub. Date: Jan. 30, 2003

(54) Projection display system in which remote control signals are transmitted to a screen

(75) Inventors: Seung-Tae Jung, Gyeonggi-do (KR); Byeong-Cheon Koh, Gyeonggi-do (KR); Cheol-Sung Yeon, Gyeonggi-do (KR); Kun-Ho Cho, Gyeonggi-do (KR); Dae-Sik Kim, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/036,540

(22) Filed: Jan. 7, 2002

(30) Foreign Application Priority Data
Jul. 26, 2001 (KR) 2001-45220

(51) Int. Cl. G03B 21/26

(52) U.S. Cl. 353/30

(57) ABSTRACT

A projection display system having a projector and a screen. The screen displays an image formed by light projected from the projector and processes user control signals input by a user to transmit the user control signals to the projector. The projector projects light to the screen to form an image thereon according to the user control signals output from the screen.

### CROSS-REFERENCE TO RELATED APPLICATIONS

This application claims the benefit of Korean Application No. 2001-45220, filed Jul. 26, 2001, in the Korean Industrial Property Office, the disclosure of which is incorporated herein by reference.

### BACKGROUND OF THE INVENTION

1. Field of the Invention

The present invention relates to a projection display system, and more particularly, to a projection display system having a projector and a screen.

2. Description of the Related Art

FIG. 1 shows a first embodiment of a conventional projection display system. Referring to FIG. 1, a projector 11 is placed on a desk 14, and a screen 12 is installed on a wall 1f. The projector 11 processes a video signal output from a video tape recorder 13 and projects light onto the screen 12 to form an image thereon. The projector 11 also processes an audio signal output from the video tape recorder 13 to generate sound. In this first embodiment of a conventional projection display system, there is a problem in that the projector 11 takes up space needed by a user 15.

FIG. 2 shows a second embodiment of a conventional projection display system. Referring to FIG. 2, a projector 21 is installed at a ceiling 1u, a screen 22 is installed on a wall 1f. The projector 21 processes a video signal output from a video tape recorder 13 and projects light onto the screen 22 to form an image thereon. The projector 21 also processes an audio signal output from the video tape recorder 13 to generate sound. A user 15 uses a remote controller 211 to control the operation of the projector 21. In this second embodiment of a conventional projection display system, the projector 21 is installed at the ceiling 1u. Thus, there is a problem in that the user 15 must transmit remote control signals to the ceiling 1u. Furthermore, the attachment of the projector to the ceiling 1u may become unstable, and the appearance of the ceiling 1u is aesthetically displeasing.

### SUMMARY OF THE INVENTION

Accordingly, it is an object of the present invention to provide a projection display system which does not take up space needed by a user, is convenient for the user to operate, and has improved stability and aesthetic value.

Additional objects and advantages of the invention will be set forth in part in the description which follows and, in part, will be obvious from the description, or may be learned by practice of the invention.

The foregoing and other objects of the present invention are achieved by providing a projection display system having a projector and a screen. The screen displays an image formed by light projected from the projector and processes user control signals input by a user to transmit the user control signals to the projector. The projector projects light to the screen to form an image thereon according to the user control signals output from the screen.

In the projection display system according to the present invention, a user can transmit control signals toward the screen. Thus, it is convenient for the user to operate the projection display system. Also, the projector can be installed on a wall behind the user, and thus the projection display system does not occupy the user's needed space and stability and aesthetics are improved.

The screen receives a video signal, an audio signal, and a television signal, generates sound based on the audio signal and an audio signal derived from the television signal, and radio transmits the video signal and a video signal derived from the television signal to the projector. The projector processes the video signals output from the screen and projects light to the screen to display an image thereon. As a result, sound is generated from the screen, thus providing a more realistic audio and visual experience.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 shows a first embodiment of a conventional projection display system;

FIG. 2 shows a second embodiment of the conventional projection display system;

FIG. 3 shows an embodiment of a projection display system of the present invention;

FIG. 4 shows the front of a screen of the projection display system shown in FIG. 3; and

FIG. 5 is a block diagram showing the circuit configuration of the projection display system shown in FIG. 3.

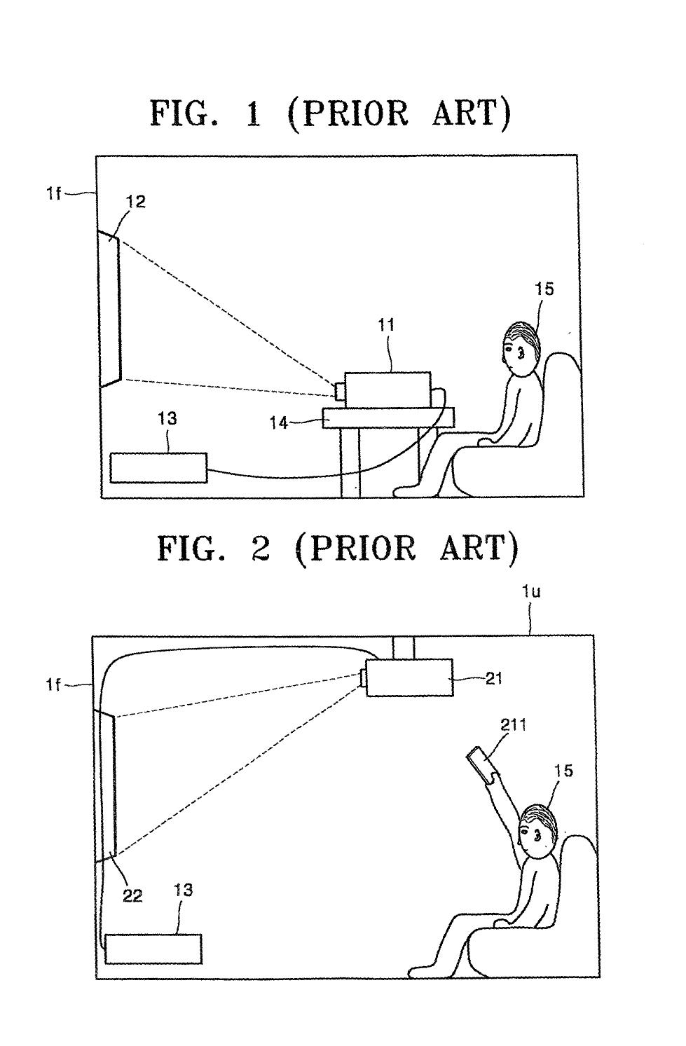

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

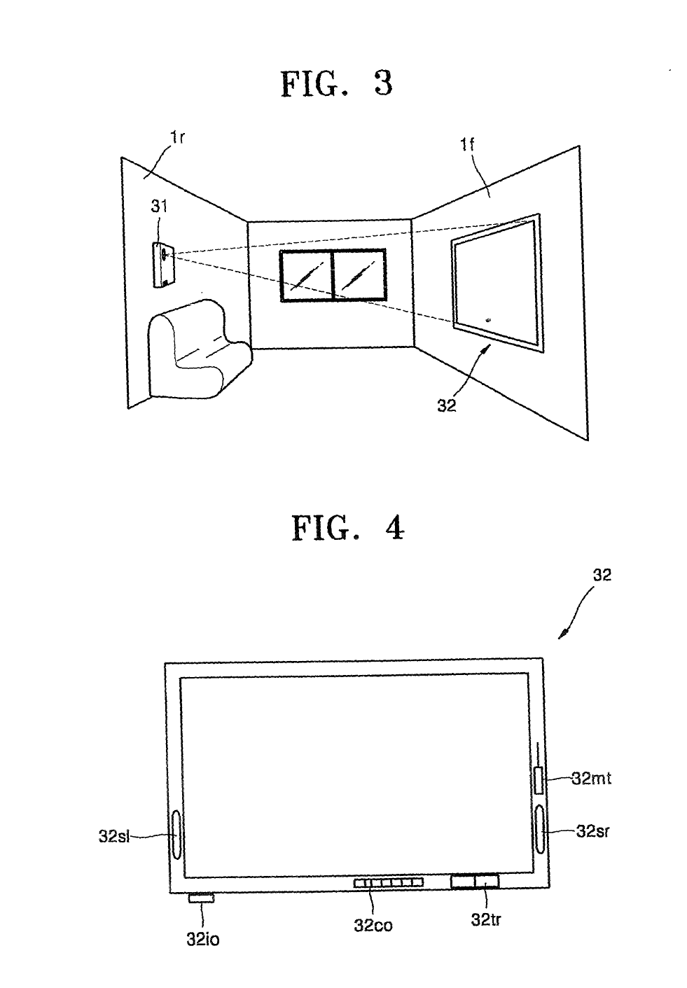

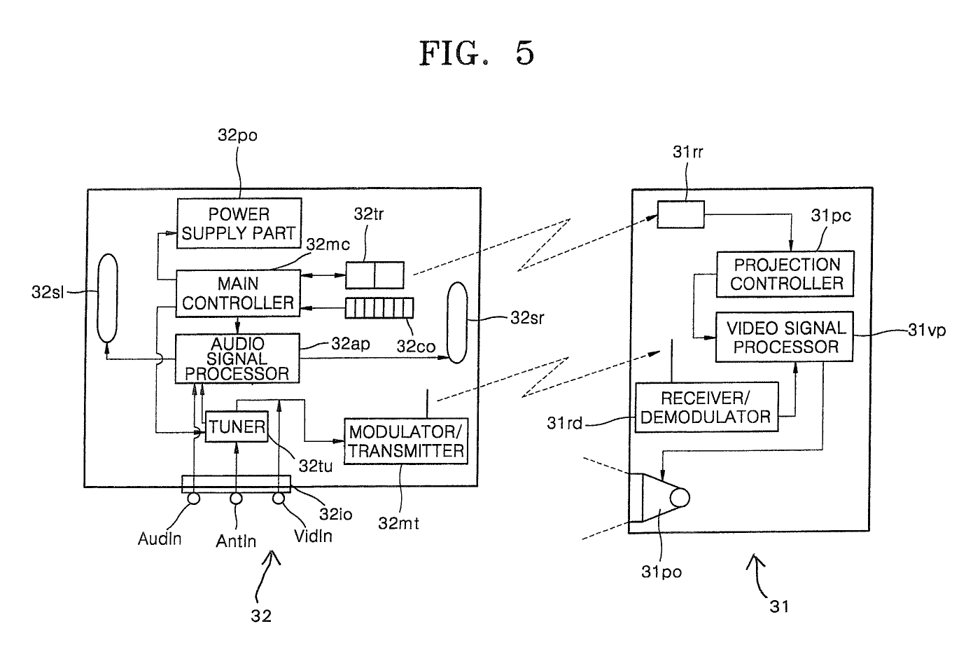

Referring to FIGS. 3, 4, and 5, a projection display system according to the present invention includes a projector 31 and a screen 32. The screen 32 displays an image by receiving light projected from the projector 31, processes control signals input by a user, and transmits the control signals to the projector 31. The projector 31 operates according to the control signals output from the screen 32 and projects light onto the screen 32 to form the image. In the projection display system according to the present invention, the user can transmit the control signals toward the screen 32 installed on a wall 1f in front of the user. Thus, it is convenient for the user to operate the projection display system. Also, the projector 31 may be installed on a wall 1r behind the user. As a result, the projection display system does not occupy the user's space, thereby improving aesthetics and stability.

The screen 32 receives a video signal, an audio signal, and a television signal from a VTR (not shown) or the like, either wirelessly or by wire. The screen 32 then generates sound according to the audio signal and an audio signal derived from the television signal, and radio transmits the video signal and a video signal derived from the television signal to the projector 31. The projector 31 processes a video signal output from the screen 32 and projects light onto the screen 32 to form an image. As a result, sound is generated from the screen 32, thus providing a more realistic audio and visual experience.

The screen 32 includes a signal input/output port 32io, a tuner 32tu, a modulator/transmitter 32mt, speakers 32sl and 32sr, an audio signal processor 32ap, a first remote transceiver 32tr, a main controller 32mc, a user controller 32co, and a power supply part 32po.

The signal input/output port 32io includes a video signal input terminal VidIn, an audio signal input terminal AudIn, and a television signal input terminal AntIn. The tuner 32tu tunes a television signal input from the television signal input terminal AntIn based on a tuning control signal input from the main controller 32mc to generate an audio signal and a first radio frequency image signal. The modulator/transmitter 32mt modulates a video signal input to the video signal input terminal VidIn into a second radio frequency image signal to radio transmit the second radio frequency image signal to a receiver/demodulator 31rd of the projector 31. The modulator/transmitter 32mt receives the first radio frequency image signal from the tuner 32tu and then radio transmits the first radio frequency image signal to the receiver/demodulator 31 rd of the projector 31. The speakers 32sl and 32sr generate sound according to audio signals input from the audio signal processor 32ap. The audio signal processor 32ap processes the audio signals input to the audio signal input terminal AudIn and output from the tuner 32tu to input them into the speakers 32sl and 32sr.

A first remote receiver in the first remote transceiver 32tr receives user control signals from a user's remote controller (not shown). The main controller 32mc processes tuning and sound control signals of the user control signals output from the first remote receiver in the first remote transceiver 32tr and from the user controller 32co to control the tuner 32tu and the audio signal processor 32ap. The main controller 32mc processes power control signals of the user control signals output from the first remote receiver in the first remote transceiver 32tr and from the user controller 32co to control the operation of the power supply part 32po. The main controller 32mc processes and outputs projection-image control signals of the user control signals output from the first remote receiver in the first remote transceiver 32tr. Here, the projection-image control signals are signals to control an image, which will be projected from the projector 31. The first remote receiver in the first remote transceiver 32tr radio transmits the projection-image control signals output from the main controller 32mc to a second remote receiver 31rr of the projector 31.

The projector 31 includes a receiver/demodulator 31rd, a video signal processor 31vp, the second remote receiver 31rr, a projection controller 31pc, and a projection output part 31po. The receiver/demodulator 31rd receives, demodulates and outputs the radio frequency image signal output from the modulator/transmitter 32mt in the screen 32. The video signal processor 31vp processes a video signal output from the receiver/demodulator 31rd to generate display driving signals. The second remote receiver 31rr receives the projection-image control signals from the first remote receiver in the first remote transceiver 32tr of the screen 32. The projection controller 31pc controls the operation of the video signal processor 31vp depending on the projection-image control signals input to the second remote receiver 31rr. The projection output part 31po includes a lens and a display panel, e.g., a liquid display panel to create an image according to the display driving signals output from the video signal processor 31vp and project light to the screen 32.

As described above, in a projection display system according to the present invention, a user can transmit control signals toward a screen. Thus, it is convenient for the user to operate the projection display system. Also, a projector can be installed on a wall behind the user, and thus the projection display system does not occupy space needed by the user, and stability and aesthetics are improved.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A projection display system comprising:
a projector to project light to form an image; and
a screen to receive the projected light and display the image, to process user control signals input to the screen by a user and to transmit the user control signals to the projector, the projector operating according to the user control signals transmitted by the screen.

2. The projection display system of claim 1, wherein:
the screen receives a first video signal, a first audio signal, and a television signal, generates a sound based on the first audio signal and a second audio signal derived from the television signal, and radio transmits the first video signal and a second video signal derived from the television signal to the projector, and
the projector processes the first and second video signals transmitted by the screen to project the light to the screen to display the image thereon.

3. The projection display system of claim 2, wherein the screen comprises:
a signal input/output port having a video signal input terminal to input the first video signal, an audio signal input terminal to input the first audio signal, and a television signal input terminal to input the television signal;
a tuner to tune the television signal input to the television signal input terminal based on a tuning control signal, to generate the second audio signal and a first radio frequency image signal;
a modulator/transmitter to radio transmit the first radio frequency image signal to the projector;
an audio signal processor to process the first and second audio signals and generate a processed audio signal therefrom;
a speaker to generate the sound based upon the processed audio signal;
a first remote receiver to receive the user control signals;
a main controller to process tuning and sound control signals of the user control signals output from the first remote receiver to control the tuner and the audio signal processor and to process and output projection-image control signals of the user control signals output from the first remote receiver; and
a first remote transmitter to radio transmit the projection-image control signals output from the main controller to the projector.

4. The projection display system of claim 3, wherein the modulator/transmitter modulates the first video signal input to the video signal input terminal into a second radio frequency image signal, and the projector comprises:
a receiver/demodulator to receive and demodulate the second radio frequency image signal into a third video signal and to output the third video signal;
a video signal processor to process the third video signal to generate display driving signals;
a second remote receiver to receive the projection-image control signals output from the first remote transmitter;
a projection controller to control the operation of the video signal processor according to the projection-image control signals received by the second remote receiver; and
a projection output part to project the light onto the screen to create the image according to the display driving signals generated by the video signal processor.

5. The projection display system of claim 1, wherein the projector is behind the user.

6. A projection display system, comprising:
a projector to generate an image; and
a screen to display the image, and to transmit control signals received from a user to the projector,
the image being generated according to the transmitted control signals.

7. The projection display system of claim 6, wherein:
the screen receives a first video signal, a first audio signal, and a television signal, generates a sound based on the first audio signal and a second audio signal derived from the television signal, and transmits the first video signal and a second video signal derived from the television signal to the projector, and
the projector processes the first and second video signals transmitted by the screen to generate the image.

8. The projection display system of claim 7, wherein the projector is behind the user.

9. A system to display an image on a screen based upon control signals transmitted from a user to the screen, the system comprising:
a projector to generate the image according to the transmitted control signals.

10. The system of claim 9, wherein the screen receives a first video signal, a first audio signal, and a television signal, generates a sound based on the first audio signal and a second audio signal derived from the television signal, and radio transmits the first video signal and a second video signal derived from the television signal to the projector, wherein:
the projector processes the first and second video signals transmitted by the screen to project the image to the screen to display the image thereon.

11. A system to display an image projected by a projector based upon control signals transmitted from a user, the system comprising:
a screen to display the image, receive the control signals from the user, and transmit the control signals to the projector.

12. The system of claim 11, wherein the projector processes a first video signal and a second video signal derived from a television signal, the first and second video signals transmitted by the screen to project the image to the screen to display the image thereon, wherein:
the screen receives the first video signal, a first audio signal, and the television signal from an external source, generates a sound based on the first audio signal and a second audio signal derived from the television signal, and radio transmits the first video signal and the second video signal to the projector.

13. The system of claim 12, wherein the screen comprises:
a signal input/output port having a video signal input terminal to input the first video signal, an audio signal input terminal to input the first audio signal, and a television signal input terminal to input the television signal;
a tuner to tune the television signal input to the television signal input terminal based on a tuning control signal, to generate the second audio signal and a first radio frequency image signal;
a modulator/transmitter to radio transmit the first radio frequency image signal to the projector;
an audio signal processor to process the first and second audio signals and generate a processed audio signal therefrom;
a speaker to generate the sound based upon the processed audio signal;
a first remote receiver to receive the user control signals;
a main controller to process tuning and sound control signals of the user control signals output from the first remote receiver to control the tuner and the audio signal processor and to process and output projection-image control signals of the user control signals output from the first remote receiver; and
a first remote transmitter to radio transmit the projection-image control signals output from the main controller to the projector.

14. The projection display system of claim 13, wherein the modulator/transmitter modulates the first video signal input to the video signal input terminal into a second radio frequency image signal, and the projector comprises:
a receiver/demodulator to receive and demodulate the second radio frequency image signal into a third video signal and to output the third video signal;
a video signal processor to process the third video signal to generate display driving signals;
a second remote receiver to receive the projection-image control signals output from the first remote transmitter;
a projection controller to control the operation of the video signal processor according to the projection-image control signals received by the second remote receiver; and
a projection output part to project the light onto the screen to create the image according to the display driving signals generated by the video signal processor.

15. A method of projecting an image, comprising:
transmitting control signals from a user to a display;
transmitting the control signals from the display to a projector;
projecting an image from the projector according to the control signals; and
forming the image on the display.

16. The method of claim 15, further comprising:
receiving a first video signal and a television signal at the display;
transmitting the first video signal and a second video signal derived from the television signal to the projector; and
processing the transmitted first and second video signals to form the image.

17. The method of claim 16, further comprising:
receiving a first audio signal at the display;
generating a second audio signal from the television signal;
processing the first and second audio signals; and
generating a sound from the processed first and second audio signals.
